(19) United States
(12) Patent Application Publication
(10) Pub. No.: US 2007/0112951 A1
(43) Pub. Date: May 17, 2007

(54) Automatic website workload management

(76) Inventors: Joseph Bing Kong Fung, Toronto (CA); Darl Andrew Crick, Keswick (CA); Robert Michael Hunter Dunn, Toronto (CA)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/272,603

(22) Filed: Nov. 14, 2005

(51) Int. Cl. G06F 15/173

(52) U.S. Cl. 709/224

(57) ABSTRACT

The present invention is directed to a system and method of automatic site workload management (ASWM) on a website. The features or services and the associated web objects are identified which may be disabled when the workload on a website and the associated servers exceeds a defined threshold for specific server performance criteria. The web objects contain tags or identifiers which facilitate the ASWM system to selectively enable and otherwise disable the web objects when servicing a user's webpage request based upon thresholds as defined in the rules for server performance criteria. Individual web objects can be disabled or enabled to optimize the benefit on the overall website workload allowing continued website operation and transaction processing during periods of high demand.

### BACKGROUND OF THE INVENTION

The present invention relates to the field of website management, and in particular, to automatically controlling website content based upon the website workload.

The growth of internet e-commerce has allowed businesses to offer goods and services to their customers on-line. Customers can now connect via the internet to websites which provide a wide array or e-commerce applications with the expectation of availability and reliability.

The operation of websites requires various computer systems such as web servers, application servers and database servers that provide services or features such as creating and displaying web content, processing database queries, providing interactive application and processing e-commerce transactions. Traditionally, the design and provisioning of these servers is determined by the expected workload of the servers during peak user traffic to ensure availability of the website.

However, a website may receive customer traffic above and beyond the provisioned capacity when there is unexpected demand or interest in the website. Under these circumstances the website operator has to react to the workload increase manually by reducing features or services available on the website or by adding hardware to increase the processing capability. Peaks in traffic can be unexpected resulting in reduced or no service for customers and users accessing the site. This usually results in the loss of traffic, which can impact the revenue generated by the website, particularly for e-commerce based applications.

### BRIEF SUMMARY OF THE INVENTION

According to a first aspect of the present invention, a system for providing automatic website workload management for a website comprising at least one server comprises at least one web object containing management tags for providing user interactive functionality through a website; at least one reporting module for collecting performance criteria of the at least one server associated with the website; a listener module for receiving the collected performance criteria; and a rules module for managing rules defining thresholds for selectively enabling and otherwise disabling the one or more web objects of the website based on the received performance criteria from the listener module to manage workload on the website.

According to another aspect of the present invention, a method for providing automatic website workload management for a website comprising at least one server comprises providing at least one user interactive web objects of a website with website management tags; obtaining performance criteria from the at least one server associated with the website; defining thresholds for each of the performance criteria; and selectively enabling and otherwise disabling the at least one web object as determined by the performance criteria based upon the defined thresholds to manage workload on the website.

According to yet another aspect of the present invention, a computer program product for providing automatic website workload management for a website comprising at least one server comprises a computer usable medium having computer useable program code embodied therein. The computer useable program code comprises computer usable program code configured to create at least one web object containing management tags and to provide user interactive functionality through a website; computer usable program code configured to create at least one reporting module for collecting performance criteria of at least one server associated with the website; computer usable program code configured to create a listener module for receiving the collected performance criteria; and computer usable program code configured to create a rules module for managing rules defining thresholds for selectively enabling and otherwise disabling the at least one one web object of the website based on received performance criteria from the listener module to manage workload on the website.

Other aspects and features of the present invention will become apparent to those ordinarily skilled in the art or science to which it pertains upon review of the following description in conjunction with the accompanying figures.

### BRIEF DESCRIPTION OF THE SEVERAL VIEWS OF THE DRAWINGS

FIG. 1 is a schematic representation of a website connected to users via a network in which an exemplary automatic site workload management system would be implemented;

FIG. 2 is a schematic representation of an exemplary webpage in which automatic site workload management web objects are implemented;

FIG. 3 is an exemplary representation of a data processing system for an automatic site workload management system;

FIG. 4 is a schematic representation of the operation of an automatic site workload management system;

FIG. 5 is a flowchart of a method of an automatic site workload management system.

### DETAILED DESCRIPTION OF THE INVENTION

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-usable or computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java7, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

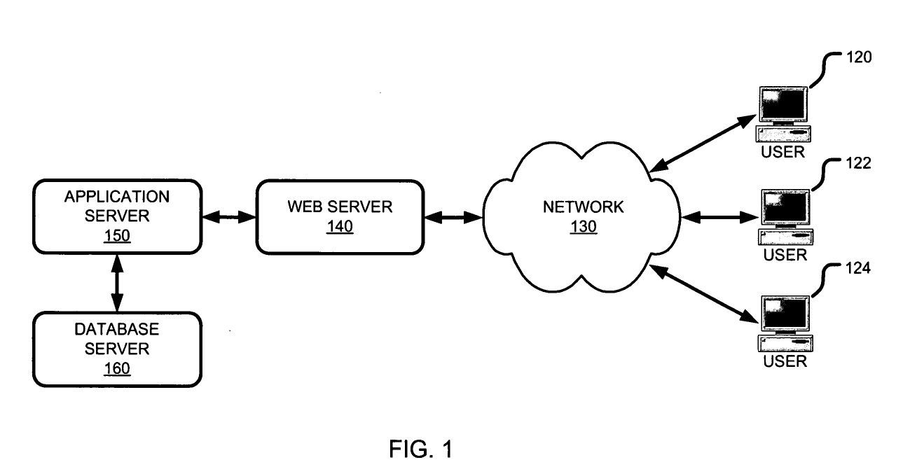

FIG. 1 is a schematic representation of a network in which a website, hosted by a web server 140, is accessible by multiple users 120, 122 and 124 connected to a network 130 such as the internet. A customer or user, for example user 120, requests web content from a website at web server 140 via the network 130. The requested web content is generated by the web server 140 and/or application server 150 and delivered via the network 130 to user 120 for display. The website may comprise a single server such as web server 140, or comprise multiple servers such as web server 140, application server 150 and database server 160. The servers provide advanced features or services for a website required for transaction processing. For example, the database server 160 may provide an inventory of products or services available to the user, while the application server 150 provides execution and generation of e-commerce applications and access to data stored on the database server 160. Interaction between each of these servers may be required to service a request by a user. When multiple users, for example users 120, 122 and 124 access the website simultaneously, the workload on the web server 140 and the backend servers (150 and 160) may increase substantially. If the workload on any of the servers exceeds the available capacity, the website may appear to be unavailable to users accessing the website. This may result in lost revenue and potentially lost traffic.

An automatic site workload management (ASWM) system allows for website capacity to be controlled by enabling continued operation of the website for processing user requests and facilitating continued revenue generation. This is facilitated by reducing the website functionality of less critical services, thereby allowing more computing resources to be available to provide more critical services. Features available to the user of a website can be dynamically reduced or disabled depending on the current workload of the website to reduce the workload exerted on the servers (140,150 and 160) of the website.

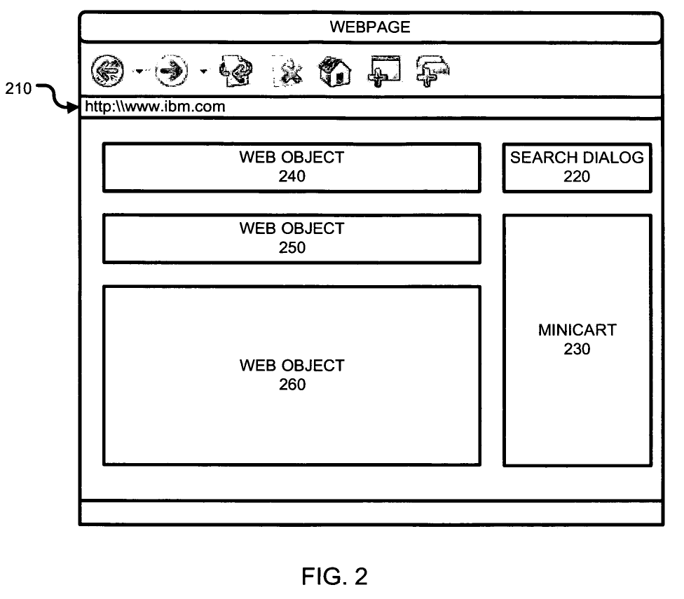

Referring to FIG. 2, a webpage 200, for a website as defined by the hypertext markup language (html) web address 210, contains various web objects displayed to the user 120. The web objects may be expressed in various forms, such as, but not limited to hypertext markup language (html), extensible markup language (xml), Java™ and ASP.net™. The objects may be dynamic or static visual objects or provide dialogs for user input or interaction which represent services available to the user. An example of a dynamic object would be a search function, a shopping cart or minicart, or any other feature that provides user interaction functionality. Static objects may be any graphic, text or an applet that does not change due to a change in users. For example, webpage 200, may contain multiple web objects 240, 250, 260 which are displayed to the user for each requested page. The web objects may also comprise features such as a search dialog 220 or shopping cart or minicart 230. By reducing the features available on the webpage by disabling the associated web objects, such as the search dialog 220 or minicart 230, the processing load on the required servers (140, 150 and 160) will also be reduced. For example, search functionality as identified as the search dialog 220, is a feature which may be disabled at peak times to reduce the workload on the application server 140 and database server 150 while allowing critical functionality of the website to continue to operate. By disabling these features and the associated web objects when server resources are in short supply, the resources of the website that are required for providing critical functions such as for example order processing, can be preserved. An additional aspect is that resources can be allocated or restricted in situations where different customer or user classes are provided to offer different levels of service. In an exemplary embodiment of the ASWM system, resources can be restricted to specific users and limit access to features when a critical resource level is reached.

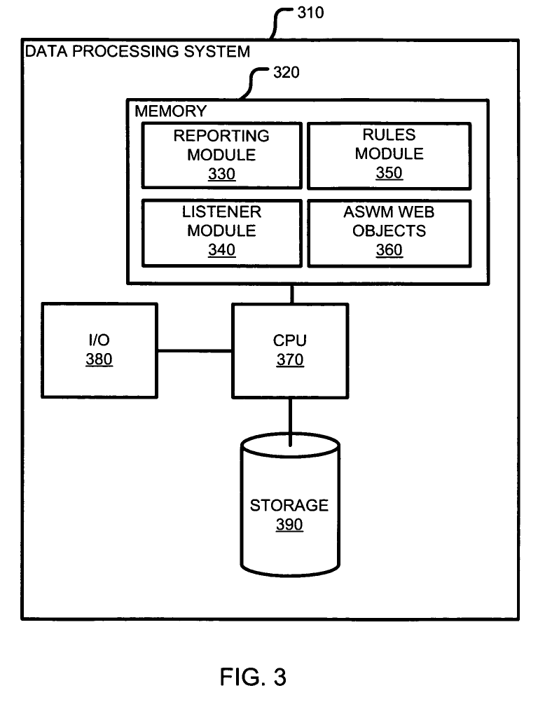

FIG. 3 shows an exemplary embodiment of an automatic site workload management (ASWM) system 300 for dynamically controlling features of a website available to a user. The ASWM system 300 includes computer executable code, which is embodied in memory 320 of a data processing system 310. The computer executable code may comprise an ASWM reporting module 330, ASWM listener module 340, ASWM rules module 350, and ASWM web objects 360. The computer executable instructions for some modules are generally previously compiled by a code compiler from high level computer programmed instructions written in a high level computer programming language. The modules may reside on the same data processing system 310, or be distributed among multiple systems or servers which may be embodied in the web server 140, application server 150 or database server 160 required for operation of the website. The hardware elements of the data processing system 310 support and execute the computer executable code included in the ASWM system 300. The data processing system 310 includes a central processing unit (CPU) 370 that provides main processing functionality. A memory 320 is coupled to CPU 370 for providing operational storage of programs and data.

Memory 320 may comprise, for example, random access memory (RAM) or read only memory (ROM). Non-volatile storage of, for example, data files and programs is provided by storage 390 that may comprise, for example, disk storage. Both memory 320 and storage 390 comprise a computer useable medium that may store computer program products in the form of computer usable or readable program code.

The ASWM web objects 360 are identified by identifiers within the coding for each object. In an exemplary embodiment of JavaServer™ Pages (JSP) code, a tag of the form <aswm:if Enabled feature=“search”>. . . </aswm:ifEnabled> is utilized to define the object that is controllable by the ASWM system. In the example provided, the name “search” is used to uniquely identify a piece of code that can be disabled.

User input and output is provided by an input/output (I/O) facility 380. The I/O facility 380 may include, for example, a graphical display, a mouse and/or a keyboard. An example of a feature on a website such as a search function in a Java JSP fragment showing the ASWM identifiers is shown below.

<!--Start Catalog Search Form-->
<aswm:ifEnabled feature=“search”>
<tr>

<tdclass=“mainHeading”width=“200”><fontclass=“mainHead
ing”>
<labelfor=“srch”><%=infashiontext.getString(“SEARCH_CA
TALOG”)%></label></font>

</td>
</tr>
<tr>

<td valign=“top” align=“left”>
<form name=“CatalogSearchForm”
action=“CatalogSearchResultView” method=“post”>
<table cellpadding=“0” cellspacing=“0”border=“0”>

<tbody><tr>

<td align=“left” valign=“middle”><input
type=“hidden” name=“storeId” value=“<%=
storeId %>” /><input type=“hidden”
name=“catalogId” value=“<%= catalogId %>”
/><input type=“hidden” name=“langId”
value=“<%= languageId %>” /> <input
type=“hidden” name=“pageSize” value=“10” />
<input type=“hidden” name=“beginIndex”
value=“0” />
<input type=“hidden” name=“sType”
value=“SimpleSearch” /> <input type=“hidden”
name=“resultType” value=“2” /> <input
size=“15” maxlength=“254” type=“text”
id=“srch” name=“searchTerm” />&nbsp;</td>
<td align=“left” valign=“middle”><a
href=“javascript:document.CatalogSearchForm.
submit( )”><img
src=“<%=jspStoreImgDir%><%=locale.toString( )
%>/<%=vfileColor%>go_button.gif”
alt=‘<%=infashiontext.getString(“GO”)%>’
width=“22” height=“18” border=“0”
/></a></td>

</tr>
<tr>

<td align=“left” valign=“top”><font
class=“mainHeading”><a
href=“AdvancedSearchView?langId=<%=languageI
d%>&storeId=<%=storeId%>&catalogId=<%=catalo
gId%>”
class=“sidebarLinks”><%=infashiontext.getStr
ing(“ADVANCED_SEARCH”)%></a></font>
</td>

</tr>

</tbody></table>
</form>
</td>

</tr>
<!--End Catalog Search Form-->
</aswm:ifEnabled>

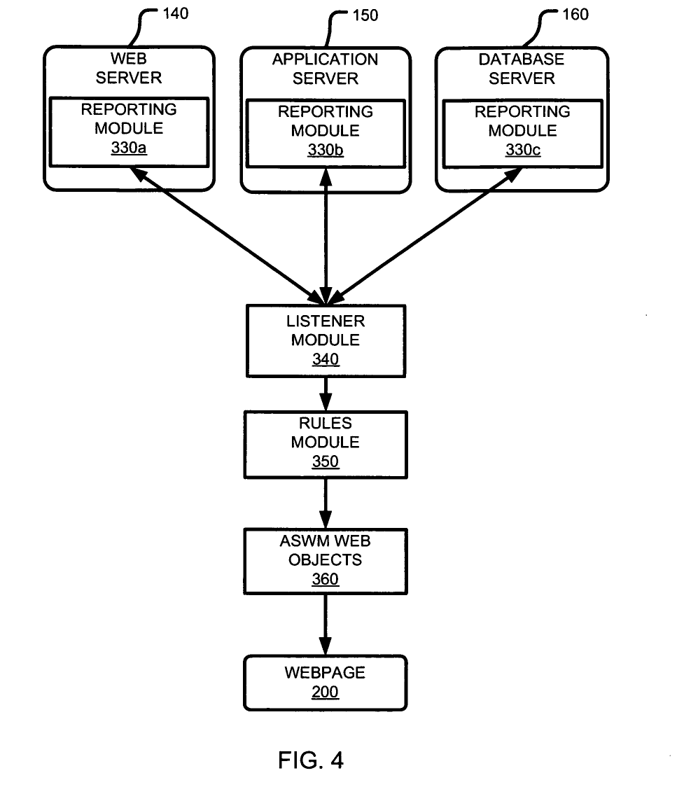

FIG. 4 is a schematic representation of operation of an ASWM system 400. The ASWM reporting module 330, resides as a process on each of the database servers (140, 150 and 160) as designated by 330a, 330b, 330c. An ASWM listener module 340 may be a process associated with one of the servers (140, 150 or 160). The ASWM listener module 340, collects all the necessary system information from the ASWM reporting processes 300a, 330b and 330c running on the respective server 140, 150 or 160. A number of criteria are collected by the ASWM listener module 300 such as, but not limited to CPU utilization, disk I/O utilization, system paging, network bandwidth utilization, the application server's 150 web container percentage of thread being utilized, the application server's 150 average response time, the database and connection pool size and Java virtual machine (JVM) memory. Any metric which provides an indication of performance may be utilized as criteria by the ASWM system.

In an exemplary embodiment such as an e-commerce implementation, an IBM® WebSphere® Application Server performance monitor interface infrastructure may be utilized in connection with the ASWM reporting module 330 to provide the ASWM listener module 340 with information (IBM and WebSphere are trademarks of International Business Machines, Inc. in the United State, other countries, or both). A separate process typically runs the ASWM listener module 340 to ensure data collection is completely asynchronous with ASWM rule module 350 execution. In an exemplary embodiment, the ASWM listener module 340 is configurable to define a mapping between a component defined in ASWM rules module 350 and an actual counter in WebSphere Application Server performance monitor interface counter in addition to the data retrieving interval.

ASWM rules module 350 defines a set of rules to determine whether a particular ASWM object (220, 230, 240, 250 and 260) should be enabled or disabled. The rules of the ASWM rules module 350 may be populated by a configuration file. The rules may define a “percentage criteria” in addition to a “duration before implementing” the rule as well as a “duration before re-enabling a service or feature”. Multiple rules may be defined for specific servers or multiple servers. In the exemplary xml file, it is defined that if the CPU or I/O utilization is more than a threshold of 80 percent, then the web object defining the search service is not enabled. In the exemplary XML sample provided below, the threshold is determined based on the weighted CPU utilization of 3 nodes, the web server 140, the database server 150 and the application server 160.

//Calculate threshold
threshold = appserver CPU utilization% × 0.3 + database server
CPU utilization × 0.6 + web server × 0.1
//Logic to determine whether search ASWM block is enabled or
not
if <aswm.component=“search”)
{

if (threshold >= 80)
{

return false;

else

return true;

}

}

When a defined criterion is met, the objects defined within the ASWM identified web objects 360 are disabled or removed from the requested webpage 200 displayed to the user. In the above example the search feature is disabled to reduce the workload that the operation of the feature would place on the database server. The defined rules are based on how critical each feature (and the related web object) is and the benefit provided to the overall workload by disabling the feature. The rules may also be defined based on the type of user accessing the site to differentiate features available to different types of user. For example, only registered users would have access to search features during periods of high demand while non-registered users would not have access to the feature. An identifier to classify users accessing the website may be utilized to identify specific users or definable groups. This allows services or features to be disabled or access restricted commencing with the least critical services until the site is running at a predetermined workload level.

Once the workload on the servers decreases, the system, through updated information reflecting the system changes obtained by ASWM listener module 340 from ASWM reporting module 330, in communication with ASWM rule module 350 causing execution of appropriate rules, can automatically enable services and or allow users access to the services. Depending on the web object and its associated feature or service, unique criteria can also be defined for disabling specific features based on the feature's impact on each server (140, 150 and 160). For example, if the database server 160 CPU utilization is high, the search feature may be disabled, however if the application server 150 CPU usage is high, specific e-commerce functions which utilized significant resources may be disabled. The rules can be defined based on the requirements of the particular web object relative to the web site infrastructure.

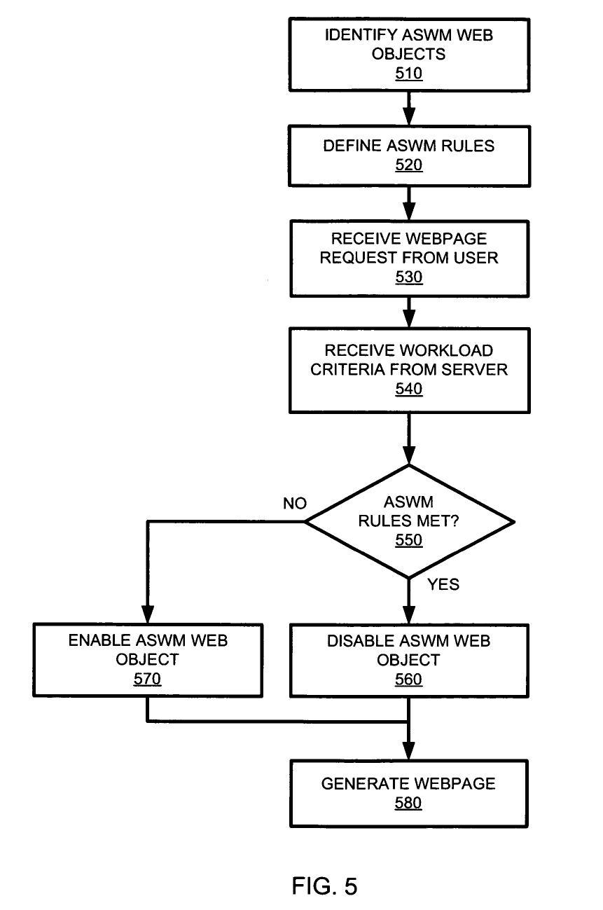

FIG. 5 is a flowchart for a method of the ASWM system 500. The web objects are identified with ASWM tags at step 510. The tags indicate which objects are to be either enabled or disabled by the ASWM process. At step 520, the rules are defined for the ASWM web objects 360 which are either to be enabled or disabled based upon server performance threshold criteria. Multiple rules may be defined for different ASWM web objects. When a webpage request is received at step 530, the performance criteria collected from the ASWM reporting modules 330 by ASWM listener module 340 is provided to the ASWM rule module 350 at step 540. The ASWM rule module 350 determines if the thresholds for criteria for any of the defined rules have been met or exceeded at step 550. If a particular rule has been met or exceeded, YES at step 550, the particular ASWM web object 360 defined in the rule is disabled at step 560, disabling the features available to the user when the webpage is generated for the end user at step 580. If the criterion defined by the rule at step 550 has not been met, the defined ASWM web object 360 is enabled or executed at step 570 when the webpage is generated at step 580.

It will be apparent to one skilled in the art that numerous modifications and departures from the specific embodiments described herein may be made without departing from the spirit and scope of the present invention. The data collection performed by the ASWM listener module 340 may be performed on the same system as the other components of the ASWM system or may be located on other systems as required. The ASWM listener module 340 may be implemented by any of the techniques known in the art including, but not limited to, utilities that perform a probe function taking samples or logging by way of taking continuous samples or snapshots as necessary to fulfill the data representation requirements. ASWM reporting module 330 may be implemented in similar fashion of ASWM listener module 340 to provide server specific monitoring capabilities to gather the required performance information.

ASWM listener module 340 may run in a continuous manner waiting for information from ASWM report module 330 or it may run intermittently as the case may be to provide the level of notification of system change as desired by a particular installation.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for providing automatic website workload management for a website comprising at least one server, comprising:
at least one web object containing management tags for providing user interactive functionality through a website;
at least one reporting module for collecting performance criteria of the at least one server associated with the website;
a listener module for receiving the collected performance criteria; and
a rules module for managing rules defining thresholds for selectively enabling and otherwise disabling the one or more web objects of the website based on the received performance criteria from the listener module to manage workload on the website.

2. The system of claim 1 wherein the at least one server associated with the website is selected from one of a web server, an application server and a database server.

3. The system of claim 1 wherein the at least one reporting module is associated with the at least one server comprising at least one of a web server, an application server and a database server.

4. The system of claim 1 wherein the listener module is associated with at least one of a web server, an application server and a database server.

5. The system of claim 1 wherein the at least one web objects is a web object comprising one of a search dialog, a minicart and a shopping cart.

6. The system of claim 1 wherein the performance criteria is defined by criteria comprising at least one of CPU utilization, disk I/O utilization, system paging, network bandwidth utilization, web container percentage of thread being utilized, average response time, database and connection pool size, and available Java virtual machine (JVM) memory.

7. The system of claim 1 wherein the thresholds managed by the rules module comprises a user type identifier for identifying individual users or a group of users.

8. A method for providing automatic website workload management for a website comprising at least one server, the method comprising:
providing at least one user interactive web objects of a website with website management tags;
obtaining performance criteria from the at least one server associated with the website;
defining thresholds for each of the performance criteria; and
selectively enabling and otherwise disabling the at least one web object as determined by the performance criteria based upon the defined thresholds to manage workload on the website.

9. The method of claim 8 wherein the at least one server of the website is a server comprising at least one of a web server, an application server and a database server.

10. The method of claim 8 wherein selectively enabling and otherwise disabling the at least one web object as determined by the performance criteria based upon the defined thresholds to manage workload on the website further comprises collecting performance criteria from at least one server associated with the website.

11. The method of claim 8 further comprising generating a web page containing the enabled at least one web objects.

12. The method of claim 8 wherein the at least one web object is a web object comprising one of a search dialog, a minicart and a shopping cart.

13. The method of claim 8 wherein the performance criteria is defined by criteria comprising at least one of CPU utilization, disk I/O utilization, system paging, network bandwidth utilization, web container percentage of thread being utilized, average response time, database and connection pool size, and available Java virtual machine (JVM) memory.

14. The method of claim 8 wherein the threshold further comprises a user type identifier for identifying users accessing the website by individual users or a group of users.

15. A computer program product for providing automatic website workload management for a website comprising at least one server, the computer program product comprising:
a computer usable medium having computer useable program code embodied therein, the computer useable program code comprising:
computer usable program code configured to create at least one web object containing management tags and to provide user interactive functionality through a website;
computer usable program code configured to create at least one reporting module for collecting performance criteria of at least one server associated with the website;
computer usable program code configured to create a listener module for receiving the collected performance criteria;
computer usable program code configured to create a rules module for managing rules defining thresholds for selectively enabling and otherwise disabling the at least one one web object of the website based on received performance criteria from the listener module to manage workload on the website.

16. The program product of claim 15 wherein the at least one server associated with the website is a server comprising at least one of a web server, an application server and a database server.

17. The program product of claim 15 wherein the reporting module is associated with at least one of a web server, an application server and a database server.

18. The program product of claim 15 wherein the listener module is associated with at least one of a web server, an application sever and a database server.

19. The program product of claim 15 wherein the at least one web object is a web object comprising one of a search dialog, a minicart and a shopping cart.

20. The program product of claim 15 wherein the performance criteria is defined by criteria comprising at least one of CPU utilization, disk I/O utilization, system paging, network bandwidth utilization, web container percentage of thread being utilized, average response time, database and connection pool size, and available Java virtual machine (JVM) memory.

21. The program product of claim 15 wherein the thresholds managed by the rules module comprises a user type identifier for identifying individual users or a group of users.
